(19) United States
(12) Patent Application Publication
(10) Pub. No.: US 2006/0101820 A1
(43) Pub. Date: May 18, 2006

(54) Ground source heat pump field design with improved control strategies

(75) Inventors: Albert A. Koenig, Coatesville, PA (US); James E. Harrell, Lafayette Hill, PA (US)

Correspondence Address: NIXON PEABODY, LLP, 401 9TH STREET, NW, SUITE 900, WASHINGTON, DC, 20004-2128, US

(73) Assignee: Geothermal Design Group, Inc., Lafayette Hill, PA (US)

(21) Appl. No.: 11/262,740

(22) Filed: Nov. 1, 2005

Related U.S. Application Data
(63) Continuation-in-part of application No. 10/825,659, filed on Apr. 16, 2004.
(60) Provisional application No. 60/463,032, filed on Apr. 16, 2003.
(60) Provisional application No. 60/463,033, filed on Apr. 16, 2003.

(51) Int. Cl. F03G 7/00

(52) U.S. Cl. 60/641.2

(57) ABSTRACT

The present invention features geothermal systems with improved control strategies for efficient operation of multiple geothermal wells. In many embodiments, each well in a geothermal system of the present invention is operated in cycles. Each cycle includes a heat exchange phase followed by a thermal recovery phase. During a heat exchange phase, the well is engaged in exchanging heat with a heat pump. During a thermal recovery phase, the well is kept inactive for establishing thermal equilibrium with the earth. On many occasions, the geothermal system simultaneously operates a group of wells in a heat exchange phase to serve the building HVAC load, while maintaining other wells inactive for thermal recovery. The switching between different operational stages is regulated for each well to improve the overall performance of the system while satisfying the building demand.

The present application is a Continuation-In-Part of U.S. application Ser. No. 10/825,659, filed on Apr. 16, 2004, which incorporates by reference the entire disclosures of U.S. Provisional Application Ser. Nos. 60/463,032 and 60/463,033, both filed on Apr. 16, 2003.

### TECHNICAL FIELD

The present invention relates to ground source heat pump systems with improved control strategies for efficient operation of multiple geothermal wells.

### BACKGROUND

Conventional heating or cooling systems require energy from limited sources which become increasingly more expensive. Much attention has been given to sources of energy which exist as natural phenomena. Such energy includes geothermal energy, solar energy, tidal energy, and wind-generated energy. While all of these energy sources have advantages and disadvantages, the geothermal energy has been considered by many as most reliable, readily available, and most easily tapped.

Ground water-based geothermal systems have been used with heat pumps or air handling units to satisfy building HVAC (heating, ventilation, and air-conditioning) loads. Geothermal systems are environmentally friendly and have low greenhouse emissions. However, a major obstacle to the widespread use of geothermal energy is the high cost associated with the initial installation or earth connection. In many cases, the payback time for installation of a geothermal system is at least 8-10 years. This makes the geothermal system economically unattractive. Therefore, there is a need for a ground source heat pump or geothermal system which has optimal performance but with reduced installation cost.

### SUMMARY OF THE INVENTION

The present invention features geothermal systems with improved control strategies for efficient operation of multiple geothermal wells. The control strategies of the present invention enable the construction of large tonnage systems which use geothermal wells with reduced drilled depths per ton. This leads to significant savings in the initial installation cost. Many of the geothermal systems of the present invention are suitable for providing continuous heating or cooling for commercial building, schools, recreational centers, or other facilities that have significant HVAC loads.

In many embodiments, a geothermal system of the present invention includes multiple geothermal wells. Each well is operated between two phases, the heat exchange phase and the thermal recovery phase. During a heat exchange phase, the well is engaged in exchanging heat with a heat pump. The well may be continuously active during a heat exchange phase. The well may also be activated intermittently during a heat exchange phase. The “on” or “off” of the well during a heat exchange phase may depend on building demand, weather conditions, or other factors. During a thermal recovery phase, the well is deactivated allowing the well to reach thermal equilibrium with the earth. Each heat exchange phase and the subsequent thermal recovery phase constitute an operational cycle of the well.

On many occasions, the geothermal system simultaneously operates a group of wells in a heat exchange phase to serve the building HVAC load, while keeping other wells deactivated for thermal recovery. The system then deactivates the group of previously active wells, while activating a group of previously inactive wells to continuously meet the building demand. This selective staging allows the system to optimize its performance and efficiency.

For each group of wells, the switching between a heat exchange phase and a thermal recovery phase may be regulated by a variety of factors. Exemplary factors include, but are not limited to, the well water temperature, the thermal recovery time, the heat exchange time, the water output of the wells, the anticipated building demand, the expected daily use, outside temperature, or climatic or building historical data records. The switching may be determined by a single or multiple factors.

In one embodiment, each well in a geothermal system of the present invention is switched from a heat exchange phase to a thermal recovery phase when the temperature of the well water reaches a predetermined threshold. In many cases, the predetermined threshold is significantly higher or lower than ambient ground water temperature. For instance, the threshold temperature can be set to have at least 10° F., 15° F., 20° F., or more temperature differential from ambient ground water temperature.

In another embodiment, each well in a geothermal system of the present invention is switched from a thermal recovery phase to a heat exchange phase after the well has been under thermal recovery for a predetermined period of time. In many cases, this predetermined period of time is no more than 48, 36, 24, 12, or less hours.

The profile of each operational cycle, such as the length of each phase in the cycle or the total water output during the cycle, can vary over a wide range (e.g., according to building demand) and need not to be repeated by any previous or future cycle. The number of operational cycles that each group of wells experiences during a heating or cooling season may also vary widely. In one embodiment, each group of wells undergoes multiple operational cycles in a heating or cooling season.

In many embodiments, the switching between a heat exchange phase and a thermal recovery phase for each well is coordinated through a control system. The control system can selectively activate certain well or wells to meet the immediate building HVAC load, while keeping other wells inactive for thermal recovery. The previously active well or wells are then deactivated while certain previously inactive well or wells are activated to continuously serve the building load. This alternate staging strategy is expected to maximize the overall performance and efficiency of a geothermal system of the present invention.

Any type of well can be used in the present invention. For instance, the wells can be open loop wells or closed loop wells. A geothermal system of the present invention can include the same type or different types of wells.

In one embodiment, a geothermal system of the present invention comprises a plurality of standing column wells. Examples of suitable standing column wells include, but are not limited to, those described in U.S. Pat. No. 5,183,100. In one instance, the standing column wells are open loop wells. Each well includes an insulating sleeve extending from the bottom of the well to a height above the water level. The sleeve divides the water in the well into two areas—namely, the core area inside the sleeve and the annular area between the outside of the sleeve and the ground wall of the well. A water pump draws water from the core area and supplies it to a heat pump for heat transfer. The water is then returned to the annular area of the well. At the bottom of the sleeve, apertures or other means may be used to allow water to communicate from the annular area to the core area, thereby forming a positive circulation.

In another instance, the standing column wells are closed loop wells. Each loop includes a water circulator usually located above ground.

The wells in a geothermal system of the present invention can be arranged in any desirable pattern. For instance, the wells can be arranged in a linear, rectangular, triangular, or circular array. The wells can also be arranged in other regular or irregular patterns to meet land constraints and facilitate access to/from the building from/to the well field.

Any number of wells may be employed in a geothermal system of the present invention. In many embodiments, a geothermal system of the present invention includes at least 5, 10, 15, 20, 25, 30, or more wells. In many other embodiments, the center-to-center distance between each two wells is selected optimally so that there is no significant heat transfer between any two wells during seasonal use of the system. In one embodiment, the center-to-center distance from one well and its closest neighbor well is from 15 to 50 feet. However, the use of larger or shorter center-to-center distances is also contemplated by the present invention. In many cases, the field design minimizes land use, packing the wells as tightly as the thermal diffusivity of the geothermal rock will permit, so as to concentrate the stored energy to be utilized in the ensuing season.

In many other embodiments, the wells in a geothermal system of the present invention are constructed to have a relative low drilled depth per ton. For instance, each well in the system can have a drilled depth per ton typically in the range of 50-125 feet per ton according to the thermal properties of the rock. As used herein, a “ton” is equivalent to 12,000 British thermal units (Btu) per hour. A “Btu” is the amount of heat required to raise the temperature of one pound of water one degree Fahrenheit (1° C.). A “Btu” equals to about 252 calories.

The reduced drilled depth per ton results in decreased installation cost without compromising the large tonnage capacity of the system. In many cases, the geothermal systems of the present invention have a heat exchange capacity of at least 200, 300, 400, 500, or more tons.

Other features, objects, and advantages of the present invention are apparent in the detailed description that follows. It should be understood, however, that the detailed description, while indicating preferred embodiments of the invention, are given by way of illustration only, not limitation. Various changes and modifications within the scope of the invention will become apparent to those skilled in the art from the detailed description.

### BRIEF DESCRIPTION OF THE DRAWINGS

The drawings are provided for illustration, not limitation.

FIG. 1 illustrates thermal relaxation of a borehole after several days of continuous heating.

FIG. 2 demonstrates a rapid exponential recovery of water temperature in a standing column well immediately after the well is inactivated.

FIG. 3 shows a mathematic model extrapolating the observation of FIG. 2 to approximately half a day.

FIG. 4 depicts an exemplary geothermal well array of the present invention, wherein the array includes five rows of standing column wells, and each row has five wells connected to a common header.

FIG. 5 shows another geothermal system according to the present invention, wherein the system includes two sets of 5×7 standing column wells and has at least 600 tons heat exchange capacity.

### DETAILED DESCRIPTION

A typical geothermal system of the present invention includes two or more geothermal wells operated between the heat exchange phase and the thermal recovery phase. During a heat exchange phase, the well is engaged in exchanging heat with a heat pump or another heat exchange device. During a thermal recovery phase, the well substantially (including completely) regains thermal equilibrium with the surrounding earth. Each heat exchange stage and the subsequent thermal recovery stage constitute an operational cycle of the well. The system is capable of allowing certain wells to be actively engaged in serving the building HVAC load, while keeping other wells inactive for thermal recovery. The switching between different operational stages is regulated for each well to sustain the continuous heat exchange demand while allowing exhausted wells to have an effective thermal recovery.

In many embodiments, each well in a geothermal system of the present invention undergoes multiple cycles in a single heating or cooling season. Each cycle has a relatively short thermal recovery phase, such as no more than 48, 36, 24, 12, or less hours. As compared to a control strategy with no or extended recovery, the control strategies of the present invention may maximize the overall performance and efficiency of the system.

Any type of geothermal well may be used in the present invention. Examples of wells include, but are not limited to, open loop wells and closed loop wells. A geothermal system of the present invention can include the same type or different types of wells. The wells can be arranged in a variety of patterns. Exemplary patterns include, but are limited to, linear, rectangular, triangular, or circular arrays. Other regular or irregular patterns may also be used. In many cases, the center-to-center distance between each two wells is selected such that no significant thermal transfer occurs between the wells during the peak use of the system.

In one embodiment, a geothermal system of the present invention employs a group of standing column wells to serve the building load. A typical standing column well includes a borehole that is cased until competent bedrock is reached. In some examples, the diameter of the borehole ranges from 6 to 10 inches. The casing can prevent ground water from entering the wet well and contaminating the water therein. The well extends into bedrock which is composed of tightly compressed stabilized ground. The bedrock usually provides ample support for the remaining depth of the well. In an open loop system, a pipe is dropped into the well to form a core through which water is pumped up, and an annulus into which water is returned. The bottom of the pipe may be perforated to form a diffuser which serves as a filter for the returned water. Thus, an open loop standing column well acts as both a supply well and a diffusion well.

In a closed loop standing column system, the water supply pipe is connected to the water return pipe to form a closed loop. The pipes are usually made of continuous plastic “polypipe” and filled with a freeze protected fluid. To promote thermal contact to the wellbore, the pipe loop can be embedded in a high conductivity grout, which is injected into the well at the time of completion displacing the water.

In many instances, the performance of a standing column well is independent from the presence or flow of ground water. However, fractures in the bedrock may be desirable in certain instances. These fractures allow water flow across the well, thereby enhancing performance and reducing the required depth. Comparing to other types of open loop well systems, a standing column well has a predictable performance without an extensive hydrogeological study. This can significantly reduce the design cost and time.

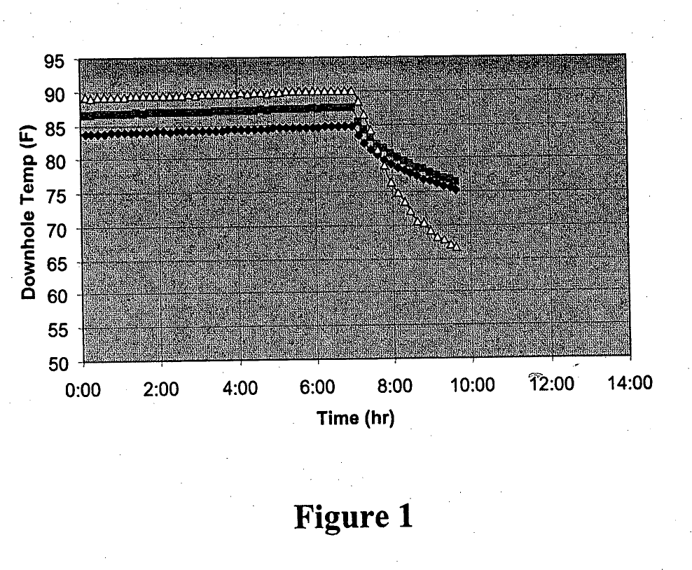

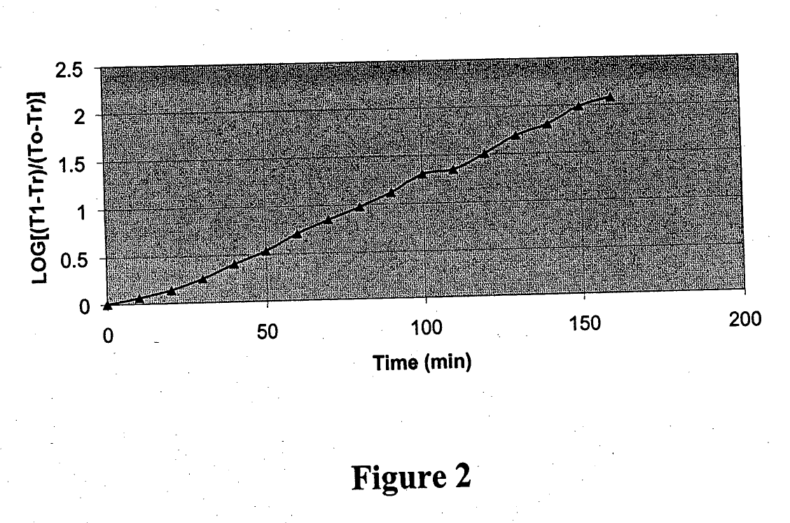

Examples of suitable standing column wells are provided by U.S. Pat. No. 5,183,100, the entire contents of which are incorporated herein by reference. A standing column well can be an open loop well, such as that depicted in FIG. 1, 3, or 4 of U.S. Pat. No. 5,183,100. A standing column well can also be a closed loop well, such as that illustrated in FIG. 2, 5, or 6 of U.S. Pat. No. 5,183,100.

In one embodiment, a standing column well employed in the present invention includes an insulating sleeve extending from the bottom of the well to a height above the water level. The insulating sleeve divides water in the well into two areas, a core area inside the sleeve and an annular area outside the sleeve. The insulating sleeve is made of material(s) that can reduce or minimize heat and direct mass transfer between the two areas. In many cases, the bottom or lower part of the sleeve is designed to allow water to communicate between these two areas. A water pump can be used to draw water from inside the sleeve and supply it to a heat pump or another heat exchange device. The water is returned to the annular area after heat exchange. The thermally recovered water then enters the sleeve at the bottom of the well and continues the circulation. This design allows the wellbore surface area in intimate contact with the water. In addition, the well forces the water to traverse the entire length of the well before returning in the sleeve, improving the heat transfer between the water and the well wall.

Since the water in a standing column well is used intermittently on demand, the water temperature may rise (during building cooling) or fall (during building heating), deviating away from groundwater ambient temperature. This can result in decreased heat pump efficiencies and increased electrical utilization associated with water pumping or back-up heating or cooling.

A standing column well can recover thermally when it remains inactive, so as to equilibrate thermally with the rock of the wellbore. Experiments showed that about half of a day is required for establishing substantial thermal equilibrium (including full equilibrium) with bedrock. The mechanism for equilibrium includes conduction and convection of the well water to the face of the rock wellbore, along with thermal diffusion from the wellbore rock.

Observation of thermal relaxation in a standing column well is evidenced in FIG. 1. The conditions of operation for this testing were such that several days of continuous heating had taken place to support a determination of the thermal properties of the wellbore rock indigenous to this test site. At the end of this heating period, water in the standing column well had reached a temperature approaching 90° F. Subsequent to this period, the heating pump was turned off and the thermal relaxation of the water well was recorded as a function of time. Detectable recovery was first observed around 7 hours after the end of heating. The recovery approached thermal equilibrium after 10 hours.

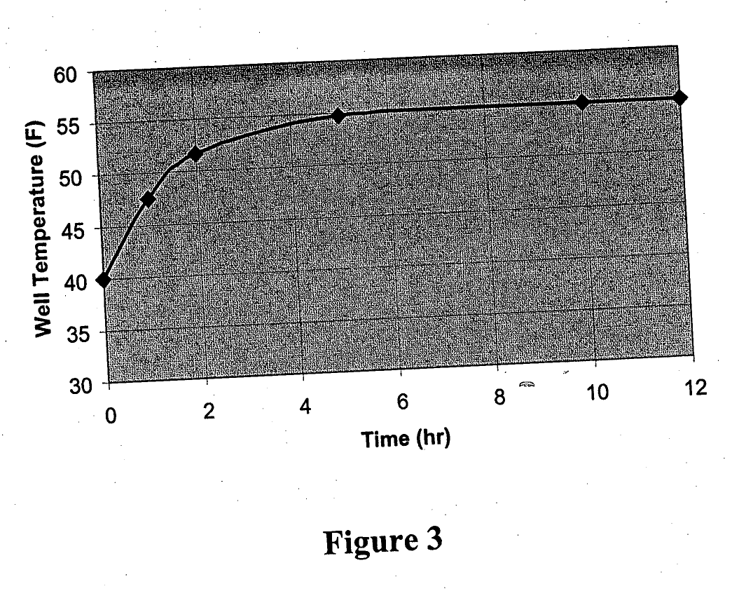

FIG. 2 indicates a rapid exponential initial recovery of water temperature in a standing column well after the well is deactivated. “To” denotes water temperature being recorded. “Tl” represents the water temperature at initiation of the recovery. “Tr” is the water temperature at thermal equilibrium. FIG. 3 shows a mathematic model extrapolating the observation of FIG. 2 to approximately half a day. FIGS. 2 and 3 demonstrate that the majority of the recovery occurs within 6 hours.

This transient behavior of ground water wells allows for a design of a large tonnage field by using multiple wells. A control system can be used to regulate the switching between heat exchange and thermal recovery for each well in the field. At one stage, the control system may keep some wells inactive while allowing others to be actively engaged in meeting the building load. At the next stage, certain wells that are previously in the heat exchange stage are inactivated, while certain other wells that are previously in the thermal recovery stage are activated. The amount of time that a well is inactive, subsequent to heat exchange operation, allows for thermal relaxation and recovery to near-ambient groundwater temperature. This control strategy provides more efficient and cost effective operation of the overall well field.

A variety of means can be used to regulate the switching between the heat exchange phase and the thermal recovery phase of a geothermal well. In one embodiment, a temperature sensor is used to monitor the temperature of ground water that is supplied to the heat pump. The sensor can be installed, for example, within the well or along the water supply line. Once the ground water reaches a threshold temperature, the system deactivates the well by, for example, turning off the water pump which draws water from the well, closing a gate valve to stop water flow, or deactivating the heat pump such that no heat transfer occurs between the ground water and the heat pump. Likewise, once a recovering well reaches a threshold temperature, such as a temperature in the proximity of ambient ground water temperature, the well becomes activated. Other factors, such as the anticipated building demand, the expected daily use, outside temperature, climatic or building historical data records, the recovery time, or the heat exchange time, may also be used to regulate the heat exchange/thermal recovery switching of a geothermal well. In addition, the water flow from each well may be adjusted (e.g., through variable speed or two speed motor), adding another layer of complexity for efficient operation and control of the well field. The activation and deactivation of wells are coordinated such that the system continuously meets the building heat exchange demand.

In another embodiment, the switching between different operational phases is controlled by a program or timer. For instance, a well or a group of wells can be kept running for a per-determined period of time, and then deactivated for another pre-determined period of time before being activated again.

The operational staging of wells in a geothermal system of the present invention can be regulated manually, automatically, or both. In many embodiments, a circuit, a processor, or a computer is used to coordinate the operation of different wells. Algorithms utilizing, for example, fuzzy logic learning can also be used to determine which well or wells are to be activated or inactivated.

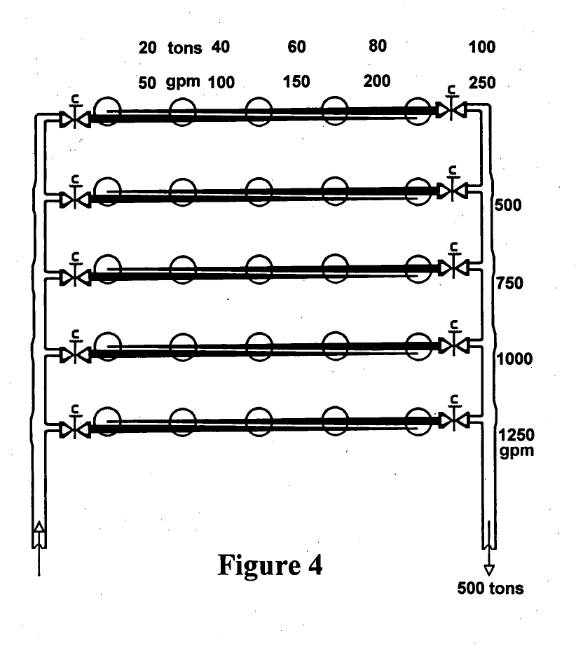

The alternate staging control strategy of the present invention is advantageous to the overall operation of geothermal systems of the present invention. FIG. 4 depicts an exemplary well array of the present invention. The wells in the array are connected in rows to a common header for supply to and return from the building heat exchanger. Each well has about 20-ton heat transfer capacity. The water flow from each well can be controlled at about 50 gallons per minute (gpm). The gate valve “c” regulates the water flow of each row of wells. At the lowest demand, a single row can be activated to serve the load. At the highest demand (e.g., the worst weather condition), the entire field can be operational. Intermediate conditions can be served by staging one or more rows on and off to increase the quiescent time for any given row in the field. Supplemental heating or cooling facility may be installed to meet the building load during a sustained harsh winter. In addition, a bleed system can be used during peak heat rejection or extraction periods. The bleed system does not return all water to the same well after heat exchange. Instead, it bleeds at least some water into other places. This can cool the well during peak heat rejection, and heat the well during peak heat exaction.

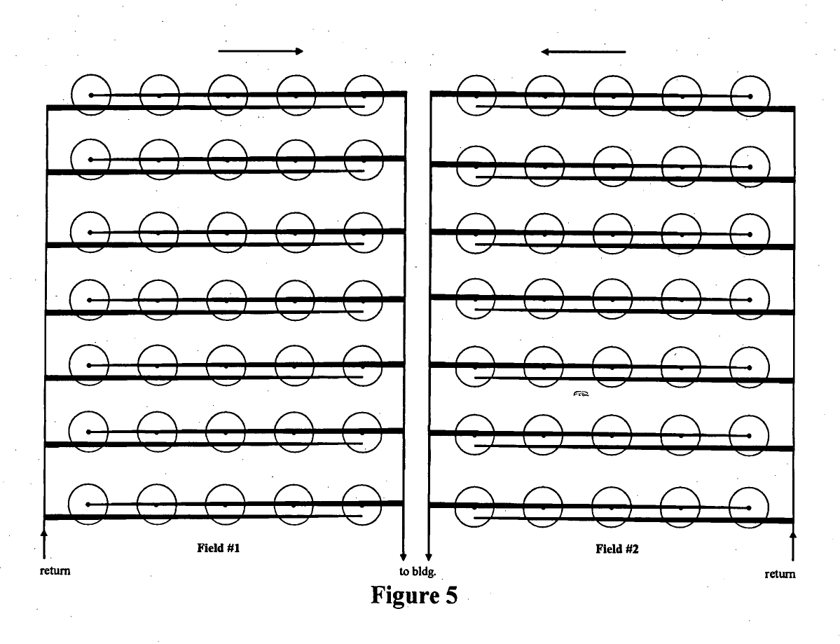

FIG. 5 illustrates another exemplary geothermal system of the present invention. The system includes 70 open loop standing column wells. Each well has an 8-inch wellbore and a depth of about 1,000 feet. The well spacing between each well is 20 feet center to center. Each well can provide about 20 gpm water flow. The 70 wells are arranged into two separate fields (Field #1 and Field #2). Each field includes 7 branch runs (parallel rows in each field), each branch run having 5 wells, providing a total water flow of 100 gpm per row. Each field is capable of providing 700 gpm water flow and 300 tons heat exchange capacity. In one scheme, the control system operates only one field per day, switching to the other field the next day. The staged relaxation allows at least partial recovery of previously used field while maintaining the necessary heat exchange capacity to serve the building load. During excessive heating or cooling, both fields can operate together to meet peak load.

The installation and operation of a geothermal system of the present invention may be affected by various factors. These factors include, but are not limited to, the field size, the hydrogeological property or thermal conductivity of the field ground, the number of wells, the distribution pattern of the wells, the drilled depth of each well, and the building load profiles. Undersized field installations require higher duty cycles, which may result in more extreme water temperatures and lower HVAC performance in certain cases. Oversized field designs, on the other hand, require more wells, pumps and field plumbing and therefore can be more expensive. The detailed knowledge of the field rock (e.g., porosity, permeability, thermal diffusivity, heat capacity, or other aquifer parameters) may facilitate the determination of the appropriate drilling depth for each well. Some of the information may be obtained during the drilling operation.

In many embodiments, the wells employed in the present invention have a drilled depth per ton less than that of traditional groundwater system installations (e.g., 45-120 feet per ton versus 150-200 feet per ton). This may represent a significant decrease in the initial installation cost. In some cases, the wells used in the present invention have drilled depths per ton of no more than 125, 100, 75, 50 feet per ton. Despite the reduced drilled depth per ton, many of the geothermal systems of the present invention can sustain large tonnage capacity (e.g., 200, 300, 400, 500, or more tons) over an extended period of time. This can be achieved by using the staged control strategy of the present invention, which allows certain wells in the field to be operatively active while others are inactive to permit rapid thermal equilibration.

The distribution pattern of the wells can also affect the operation or efficiency of a geothermal system of the present invention. For many geothermal fields, the thermal conductivities of ground materials are relatively low. See, for example, Table 1 of U.S. Pat. No. 5,183,100. A previous study measured the thermal effect of an operatively active standing column well on an adjacent standing column well. The active well was 1050 feet deep with static water at about 125 below grade (i.e., a 900 feet wetted wall surface for heat transfer). The well was operated in conjunction with 20 tons of connected ground water heat pumps. With a bedrock temperature of about 55° F. and a returned water temperature of up to 90° F. into the annular space in the borehole, it took three months to detect any temperature increase in an adjacent well of 300 feet deep, which is only 10 feet away. This study indicated that the movement of energy between deep wells is considerably slow. Combined with the alternate staging control strategy of the present invention, the slow movement of ground heat allows a design of a field in which the center-to-center distance between each two nearest standing column wells can be as little as 15 to 20 feet, as compared to 50-75 feet required by a typical traditional design.

In many embodiments, a geothermal system of the present invention is designed such that the center-to-center distance from each well in the system to its closest neighbor well is no more than 50 feet. The use of larger or shorter center-to-center distances is also contemplated by the present invention.

Furthermore, the “flywheel effect” can be employed in the present invention. The “flywheel effect” reflects the energy stored in bedrock or other ground surroundings due to the use of a geothermal well. For instance, during the summer cooling season, heat is rejected into bedrock surrounding the well. The temperature of the surrounding bedrock would be higher after the summer than the prevailing bedrock temperature. This stored energy can be extracted and utilized during the next winter heating season. Likewise, the temperature of bedrock surrounding the well may be lower than the prevailing bedrock temperature after a heat extraction season. This lower temperature may be exploited during the next heat rejection season. A computer can be used to record or analyze the “flywheel effect” for each well. The operation of each well can be adjusted accordingly to reflect that effect.

In addition, the “thermal boost” effect can be factored into the design or operation of a geothermal system of the present invention. The thermal boost is caused by water flow and thermal diffusion between aquifers in a deep borehole. The “thermal boost” effect can be experimentally measured or refined and thermally tested. The effect enhances the heat exchange capacity of a water well.

Any type of heat exchange device may be used to extract or reject heat from/to a geothermal well. Examples of suitable heat exchange devices include, but are not limited to, various heat pumps. A heat pump extracts heat from one source and transfers it to another. In many embodiments, the heat pumps are reversible and have both heating and cooling modes. The heat pumps can be, without limitation, a water-to-air pump, a water-to-water pump, or a water-to-air split type.

In one embodiment, a geothermal system of the present invention includes a thermal storage to store heat unused during off peak periods. For instance, water heated by a heat pump can be stored in an insulating tank and used when needed. The thermal storage can also be used to collect heat generated from other renewable sources of energy, such as solar energy.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

1. A ground source heat pump system comprising:
a plurality of geothermal wells, said plurality of geothermal wells being arranged in an array pattern, and each of said plurality of geothermal wells being substantially vertical; and
each said geothermal well being operated in cycles, each said cycle comprising a heat exchange phase followed by a thermal recovery phase,
wherein the system operates at least one of said geothermal wells in a heat exchange phase while maintaining at least one of the remaining geothermal wells in a thermal recovery phase.

2. The ground source heat pump system according to claim 1, wherein each said geothermal well is switched from a heat exchange phase to a thermal recovery phase when a predetermined condition or conditions are met.

3. The ground source heat pump system according to claim 2, wherein each said geothermal well is switched from a thermal recover phase to a heat exchange phase after the well has been in the former phase for a predetermined period of time, and wherein the well reaches a substantial thermal equilibrium with the earth during said predetermined period of time.

4. The ground source heat pump system according to claim 3, wherein the predetermined period of time is no more than 24 hours, and each said geothermal well is switched from a heat exchange phase to a thermal recovery phase when the temperature of ground water supplied by the well reaches a threshold temperature.

5. The ground source heat pump system according to claim 1, wherein each said geothermal well undergoes multiple cycles in a heating or cooling season, and each of said multiple cycles includes a heat exchange phase followed by a thermal recovery phase of no more than 24 hours before the next cycle starts.

6. The ground source heat pump system according to claim 1, wherein said geothermal wells include a plurality of standing column wells.

7. The ground source heat pump system according to claim 6, wherein each said standing column well has a drilled depth per ton of no more than 125 feet per ton, and said standing column wells have a total heat exchange capacity of at least 200 tons.

8. The ground source heat pump system according to claim 6, wherein each said standing column well has a drilled depth per ton of no more than 75 feet per ton, and said standing column wells have a total heat exchange capacity of at least 200 tons.

9. The ground source heat pump system according to claim 6, wherein said standing column wells are open loop wells, said array pattern comprising a plurality of rows of said open loop wells and ground water supplied from open loop wells in a given row is returned substantially pro rata to those open loop wells in said given row after heat exchange.

10. The ground source heat pump system according to claim 9, wherein the center-to-center distance from each said open loop well to a well nearest thereto is from 15 to 50 feet.

11. The ground source heat pump system according to claim 9, wherein said standing column wells include at least 10 open loop wells.

12. The ground source heat pump system according to claim 6, wherein each said standing column well includes:
an insulating sleeve extending from the bottom of the well to a distance above the water level inside said sleeve, said sleeve dividing the well into two areas, a core area inside said sleeve and an annular area between the outside of said sleeve and the ground wall of the well;
a water pump capable of drawing water from inside the core area and supplying said water to a heat pump; and
a return pipe through which said water is returned from the heat pump to the annular area.

13. The ground source heat pump system according to claim 1, wherein said geothermal wells comprise a plurality of closed loop wells.

14. The ground source heat pump system according to claim 1, wherein said geothermal wells are divided into at least two groups of wells, each said group being operated in cycles and each said cycle comprising a heat exchange phase followed by a thermal recovery phase, wherein the system operates at least one of said groups in a heat exchange phase while maintaining the remaining groups in a thermal recovery phase.

15. The ground source heat pump system according to claim 1, further comprising a heat pump for transferring heat from or to ground water supplied by said geothermal wells.

16. The ground source heat pump system according to claim 1, further comprising a supplementary heating or cooling system.

17. A ground source heat pump system comprising:
a plurality of standing column wells, said plurality of standing column wells being arranged in an array pattern and each of said plurality of standing column wells being substantially vertical; and
each said standing column well being operated in cycles, each said cycle comprising a heat exchange phase followed by a thermal recovery phase,
wherein each said standing column well is respectively switched from a heat exchange phase to a thermal recovery phase when a predetermined condition or conditions are met.

18. The ground source heat pump system according to claim 17, wherein the system is capable of operating at least one of said standing column wells in a heat exchange phase while maintaining the remaining of said standing column wells in a thermal recovery phase, and wherein each said standing column well undergoes multiple cycles in a heating or cooling season, and the thermal recovery phase of each of said multiple cycles lasts no more than 24 hours before the next cycle starts.

19. A method for operating a ground source heat pump system which includes a plurality of geothermal wells, said plurality of geothermal wells being arranged in an array pattern comprising:
switching each said geothermal well in a given row of geothermal wells in said array from a heat exchange phase to a thermal recovery phase when a predetermined condition or conditions are met; and
switching each said geothermal well in said given row from a thermal recovery phase to a heat exchange phase after the well has been in the former phase for a predetermined period of time;
wherein the ground source heat pump system sustains a heat exchange capacity of no less than a predetermined value.

20. The method according to claim 19, comprising switching each said geothermal well in said given row from a heat exchange phase to a thermal recovery phase multiple times during a heating or cooling season, wherein the predetermined period of time is no more than 24 hours.

21. A ground source heat pump system for heating and chilling a structure, said system comprising:
an array of wells, said array comprising a plurality of rows of said wells, each well within a respective row being interconnected in parallel; and
a switch, said switch activating or deactivating at least one of said plurality of rows upon occurrence of a condition, whereby said plurality of rows of wells are employed to heat and chill said structure.

22. The ground source heat pump system according to claim 21, wherein said switch interconnects a plurality of rows of wells in parallel, whereby water removed from wells in said plurality of rows is returned and recycled substantially pro rata to those wells after heat exchange.

23. The ground source heat pump system according to claim 21, further comprising:
a control system, said control system activates or deactivates said switch upon occurrence of said condition.

24. The ground source heat pump system according to claim 23, wherein said control system instructs said switch to selectively activate said at least one of said plurality of rows upon said condition, said control system maintaining at least one other plurality of rows in a deactivated state.

25. The ground source heat pump system according to claim 23, wherein said control system instructs said switch to deactivate all but one of said plurality of rows upon said condition.

26. The ground source heat pump system according to claim 23, wherein said control system instructs said switch to activate all of said plurality of rows upon said condition, said control system deactivating a given row upon occurrence of a second condition.

27. The ground source heat pump system according to claim 21, wherein said array of wells are arranged into a plurality of separate fields, said switch activating at least one row in a first field and deactivating all of said rows in the other fields until occurrence of said condition.

28. The ground source heat pump system according to claim 21, wherein the center-to-center distance between adjacent wells is between 15 and 20 feet.

29. The ground source heat pump system according to claim 21, wherein said condition is selected from the group consisting of well temperature, structure energy demand, building operating parameters, outside temperature, expected daily usage, historical records, recovery time, heat exchange time and operation time.

30. The ground source heat pump system according to claim 21, wherein said system operates with groundwater at ambient temperature.

31. A method for operating a ground source heat pump system having an array of wells with a plurality of rows, comprising:
activating at least one row of wells in said array upon occurrence of a first condition; and
deactivating said at least one tow in said array upon occurrence of a second condition, whereby said at least one row enters a thermal recovery phase upon deactivation.
